(19) United States
(12) Patent Application Publication
(10) Pub. No.: US 2012/0068039 A1
(43) Pub. Date: Mar. 22, 2012

(54) Support for an upright structure

(76) Inventors: Richard Erich, Gualala, CA (US); James Fey, Oakland, CA (US)

(21) Appl. No.: 12/923,353

(22) Filed: Sep. 16, 2010

(51) Int. Cl. F16M 11/22

(52) U.S. Cl. 248/519

(57) ABSTRACT

A system for supporting a super structure utilizing a plurality of blocks that are connected laterally to one another through tensioning elements. The super structure is supported to at least one of the blocks which are positioned on or near a ground surface. A plurality of piles extend through the blocks to anchor the same beneath the soil and aid in the support of the super structure.

### BACKGROUND OF THE INVENTION

The present invention relates to a novel and useful upright structure support apparatus.

Towers and antennas are widely used in communication facilities to transmit and receive signals over long distances. Such towers and antennas must be supported above a ground surface to allow the tower or antenna to extend a requisite distance in order to be effective. In the past, foundations have been employed to support such towers and antennas by providing a geological assessment, excavating soil, and employing a subterranean foundation according to an engineering plan. Unfortunately, the prior provision of foundations for super structures have been proved to be time consuming and expensive. In addition, such a system of supporting super structures is not well suited to remote areas and places of uneven or rocky terrain.

In the past, a novel system was proposed by U.S. Pat. No. 6,050,038 in which a plurality of blocks were connected to one another by tensioning members to form a unitary foundation atop a ground surface. Again, although successful in achieving super structure support, the prior method described in U.S. Pat. No. 6,050,038 requires a modest amount of expensive materials to provide the proper ballast for a particular upright structure.

A foundation apparatus for supporting an upright structure which is versatile and efficient would be a notable advance in the communication field.

### SUMMARY OF THE INVENTION

In accordance with the present invention a novel and useful foundation apparatus for supporting an upright structure is hereinafter provided.

The apparatus of the present invention utilizes a block which may be formed of concrete or similar material. The block is generally centrally located in the apparatus of the present invention. The block may be positioned essentially atop a ground surface, without the need for excavating or pouring foundational structures. The block includes hardware for fastening or holding an upright structure.

At least three base legs abut the block at proximal portions of the same. Of course, more than three base legs may be employed such as 4, 5, and the like. In any case, the at least three base legs are also positioned at the ground surface and in a similar manner to the block which serves as a hub for the three base legs. The base legs may be formed of concrete or similar material, also.

The block and base legs are normally separable from one another for the purposes of transportation and assembly. That is to say, the block and the base legs may be modular and placed together at the eventual site were the super structure is to be supported. In this regard, at least three tensioning element or rods are used to connect each of the three base legs to the block. In such a case, one tensioning rod would be use with each of the base leg relative to the block. However, it should be noted that a plurality of such tensioning rods may be used with each of the base legs relative to the block. Moreover, such tensioning rods would extend through a portion of each of the base legs and through the block. Conventional fasteners, such as nuts, may be employed with the tensioning rods, the latter being formed with threaded end portions to accommodate such fasteners.

Further, at least one ground penetrating member is extended through at least one of the base legs at the distal portion of the same in relation to the block. Again, a multiplicity of ground penetrating members may be employed with respect to each of the base legs. Each of the ground penetrating members pass through the distal portion of a particular base leg and extend downwardly into the supporting ground mass. Gout or other cementitious material may be used to secure the ground penetrating member in this position.

Another aspect of the present invention concerns the assemblage of a multiplicity of blocks without the use of base legs. Such blocks would lie adjacent to one another or be formed into units or clusters separated from one another. Each of the clusters would be linked by structural members of the super structure. Again, the plurality of blocks would be tensioned by tensioning elements and be generally supported on a ground surface without the need for ground excavation. Ground penetrating members may also be found in such cluster. Further, blocks may be stacked and tensioned vertically using tensioning elements.

It should be apparent that a novel and useful foundation apparatus supporting an upright member or super structure above a ground surface as been hereinabove described.

It is therefore an object of the present invention to provide a foundation apparatus for supporting such upright member above a ground surface which is capable of supporting an upright member by utilizing less bulk than systems of the prior art.

Another object of the present invention is to provide a foundation apparatus for supporting an upright member that possesses less weight yet achieves a large degree of resistant to overturn moment.

Yet another object of the present invention is to provide a foundation apparatus for supporting an upright member above a ground surface which is easier to ship and position in remote areas than systems of the prior art.

Another object of the present invention is to provide a foundation apparatus for supporting an upright member above a ground surface that is compatible with rocky surfaces.

A further object of the present invention is to provide a foundation apparatus for supporting an upright member above a ground surface that achieves the support of such upright surface in a less expensive manner.

The invention possesses other objects and advantages especially as concerns particular characteristics and features thereof which will become apparent as the specification continues.

### BRIEF DESCRIPTION OF THE SEVERAL VIEWS OF THE DRAWING

FIG. 1 is a top plan view of an embodiment of the present invention utilizing five base legs.

FIG. 2 is a sectional view taken along line 2-2 of FIG. 1.

FIG. 3 is a top schematic view of an embodiment of the apparatus of the present invention utilizing four base legs.

FIG. 4 is a top schematic view of an embodiment of the present invention utilizing three base legs

FIG. 5 is a top plan view system using identical blocks without base legs in order to support super structure.

FIG. 6 is a top plan view of a plurality of clusters of blocks used to support a super structure.

FIG. 7 is a side elevational view of an existing super structure showing the blocks support of the present invention, in section, reinforcing the same.

For a better understanding of the invention reference is made to the following detailed description of the preferred embodiments of the invention which should be taken in conjunction with the above described drawings.

### DETAILED DESCRIPTION OF THE PREFERRED EMBODIMENTS OF THE INVENTION

Various aspects of the present invention will evolve from the following detailed description of the preferred embodiments thereof which should be referenced to the prior described drawings.

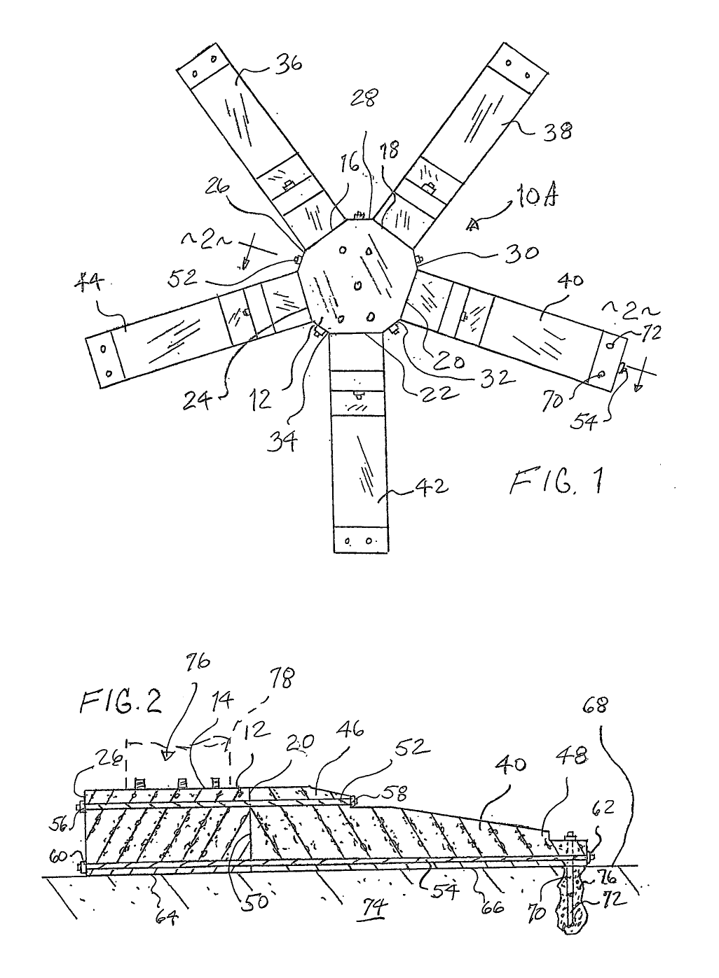

An embodiment of the invention as a whole is shown in the drawings by reference character 10 followed by an upper case letter to denote variations of the same. With reference to FIG. 1, it may be observed that structure 10A is shown. Structure 10A includes as one of its elements, block 12 which is formed of concrete or similar material. Block 12 is constructed as a faceted member having a top surface 14 and five long flattened surfaces 16, 18, 20, 22, and 24. Short flattened side surfaces 26, 28, 30, 32, and 34 lie between pairs of surfaces 16, 18, 20, 22, and 24. It should be noted that surfaces 26, 28, 30, 32, and 34 are laterally shorter than side surfaces 16, 18, 20, 22, and 24. For example, short side surface 26 lies between long side surfaces 16 and 24.

As depicted in FIG. 1, structure 10A includes base legs 36, 38, 40, 42, and 44. Each base leg fits against a long flattened surface of block 12. For example, base leg 40 lies against long flattened surface 20 of block 12. In addition, each base leg includes a proximal portion adjacent one of the long flattened surfaces 16, 18, 20, 22, or 24, and a distal portion extending away from block 12.

With reference to FIG. 2, it may be observed that exemplary block 12 is depicted in relation to base leg 40 in section. It should be noted a similar relationship occurs with respect to base legs 36, 38, 42, and 44 relative to block 12. In this regard, base leg 40 includes a proximal portion 46 and a distal portion 48. Base leg 40 tapers between proximal portion 46 and distal portion 48. Proximal portion 46 of base leg 40 includes a flattened surface 50 which abuts long side surface 20 of block 12.

Tensioning elements or rods 52 and 54 are used to interconnect block 12 to base leg 40. Tensioning rod 52 generally extends through distal portion 46 of base leg 40, through block 12 and terminates at short surface 26 of block 12. Tensioning rod 54 extends from distal portion 48 of block 42 to short surface 26 of block 12. Each tensioning rod may be threaded and accept tensioning nuts to insure the tensioned interconnection of block 12 with leg 40. For example, nuts 56 and 58 create the tensioning of tension rod 52, while nuts 60 and 62 perform the same function with regard to tensioning rod 54, FIG. 2. Likewise, tensioning elements and rods, as well as tensioning nuts, are used with respect to base legs 36, 38, 42, and 44 to hold the same in tension with block 12. It should be seen that block 12 includes a bottom 64 which lies flush with bottom 66 of leg 66, FIG. 2. Bottom 64 and bottom 66 of block 12 and base leg 40, respectively, lie at ground surface 68.

Referring again to FIGS. 1 and 2, it may be observed that ground penetrating members 70 and 72 extend through leg 40 into mass ground body 74. Grout or cementitious material 76 may be employed to hold ground penetrating members 70 and 72 in place within ground body 74. It should be realized that base leg 36, 38, 42, and 44 are also depicted in FIG. 1 as having similar ground penetrating members. Fixtures 76 extending from and held to block 12 are used to support upright member 78, shown in phantom on FIG. 2. In addition, tensioned counter weights may be employed instead of ground penetrating members 70 and 72 to hold leg 80 in place.

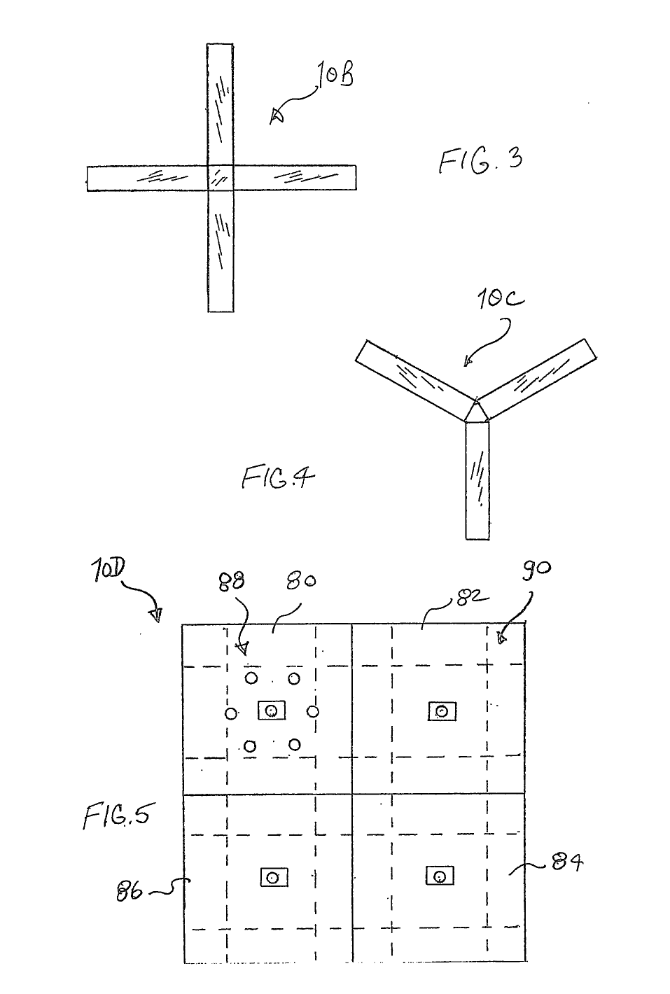

With reference to FIGS. 3 and 4, illustrate, schematically, that structures 10B and 10C are depicted using four base legs and three base legs, respectively. Needless to say, the relationship between the central block of embodiments 10B and 10C and the base legs are essentially the same as that described with respect to FIG. 1. That is to say, tensioning elements and ground penetrating members may be used with the embodiments shown in FIGS. 10B and 10C.

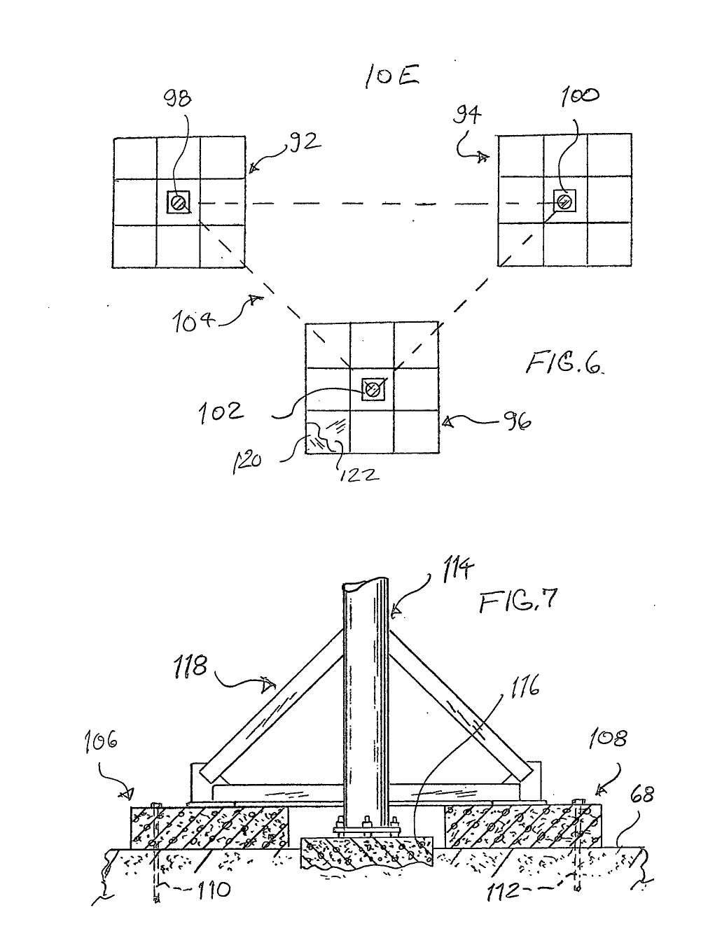

Turning to FIG. 5, it may be apparent that embodiment 10D is shown consisting of blocks 80, 82, 84, and 86 which are constructed of concrete or similar material. Block 80 includes hardware 88 which allows the fastening of an upright member, such as an upright member 78 of FIG. 2. Plurality of phantom lines 90 represent the use of tensioning elements or tensioning rods similar to tensioning rods 52 and 54 of FIGS. 1 and 2. Thus, embodiment 10B depicts a united member or cluster of tensioned blocks which serves as a weight or ballast for a supported upright member. Embodiment 10D may, again, rest upon ground surface 68 depicted in FIG. 2, and ground penetration members may also be employed with embodiment 10D.

FIG. 6, shows block units or clusters 92, 94, and 96 are employed and rest upon a ground surface such as a ground surface 68 of FIG. 2.

Blocks unit 92, 94, and 96 are fashioned in a manner similar to the block unit of embodiment of 10D of FIG. 4, with the addition of five blocks in each unit. Upright members 98, 100, and 102 of block units 92, 94, and 96, respectively extend outwardly from those units. Phantom lines 104 indicate cross-bracing which may be employed to interconnect upright members 98, 100, and 102 which may form a tower, above block units 92, 94, and 96. Block unit 96 indicates vertical stacking of blocks 120 and 122 which may be tensioned by a tension element in a vertical manner.

FIG. 7, shows another application of the present invention in which block units 106 and 108 lie on ground surface 68 and include ground penetrating members, such as ground penetrating members 110 and 112. Block units 106 and 108 are depicted as unitary structures, although they are preferably constructed according to the block unit 10D, depicted in FIG. 5. An existing upright pole 114 is connected to an existing subterranean base or caisson 116. Bases and cross members 118 are used to connect pole 114 to the hardware found atop block units 106 and 108, which are similar to those depicted in FIG. 5, with respect to block 80. Thus, the system of the present invention may be used to reinforce an existing structure consisting of existing pole 114 and subterranean base 116. It should be understood that caisson 116 may be surrounded by blocks in addition to blocks 106 and 108, for example, eight blocks may surround caisson 116.

In operation, structures 10A-10C may be formed using a central block, such as block 12 of FIG. 1, and a plurality of base legs extending therefrom, such as base legs 36, 38, 40, 42 and 44 of FIG. 1. Base legs 36, 38, 40, 42, and 44 are connected to central block 12 by tensioning elements or rods such as exemplary tensioning rods 52 and 54 with respect to block 12 and base leg 40, FIGS. 1 and 2. By changing the shape of the central block and altering the number of base legs, various configurations may be created such as those depicted in FIGS. 3 and 4, embodiments 10B and 10C. In addition, block units or cluster may be constructed as shown in FIGS. 5-7 that may be employed to support a superstructure or upright member when used in combination. The block units 106 and 108, depicted in FIG. 7 may be used to reinforce an existing upright structure 114 in the same manner. It should also be noted that block unit 96 of FIG. 6, illustrates the fact that blocks may be tensioned and stacked vertically as well as horizontally. For example block 120 lies underneath block 122. Needless to say, tensioning rods may be used horizontally and vertically to provide such a stacked configuration of FIG. 6.

While in the foregoing, embodiments of the present invention have been set forth in considerable detail for the purposes of making a complete disclosure of the invention, it may be apparent to those of skill in the art that numerous changes may be made in such detail without departing from the spirit and principles of the invention.

What is claimed is:

1. A foundation apparatus for supporting an upright member above a ground surface, comprising:
a. a block;
b. at least three base legs abutting said block at a proximal portion of each of said at least three base legs, said block and said at least three base legs positioned at the ground surface,
c. at least three tensioning elements, each of said at least three tensioning elements extending through only one of said at least three base legs and said block;
d. one ground penetrating member, said one ground penetrating member extending through at least one of said at least three base legs at its distal portion relative to said block; and
e. a connector located at said block for linkage to the upright member.

2. The apparatus of claim 1 in which said at least one of said at least three base legs tapers between said proximal and distal portions thereof.

3. The apparatus of claim 1 which said one ground penetrating member comprises a plurality of ground penetrating members.

4. The apparatus of claim 1 in which said at least three base legs lie apart from one another.

5. The apparatus of claim 1 which comprises another ground penetrating member, said another ground penetrating member extending through at least another of said at least three base legs at its distal portion.

6. A foundation apparatus for supporting an upright member above a ground surface, comprising:
a. a block;
b. at least four base legs each abutting said block at a proximal portion of each of said at least four base legs, said block and said at least four base legs positioned at the ground surface;
c. at least four tensioning rods each of said at least four tensioning elements extending through at least only one of said at least four base legs and said block;
d. one ground penetrating member, said one ground penetrating member extending through at least one of said at least four base legs at its distal portion relative to said block; and
e. a connector located at said block for linkage to the upright member.

7. The apparatus of claim 6 in which said at least one of said at least four base legs tapers between said proximal and distal portions thereof.

8. The apparatus of claim 6 which said one ground penetrating member comprises a plurality of ground penetrating members.

9. The apparatus of claim 6 which comprises another ground penetrating member, said another ground penetrating member extending through at least another of said at least four base legs at its distal portion.

10. A foundation apparatus for supporting an upright member above a ground surface, comprising:
a. a central block;
b. plurality of blocks abutling one another said plurality of blocks circumscribing said central block;
c. a plurality of tensioning elements, each of said plurality of tensioning elements extending through at least three of said of plurality of blocks, each of said plurality of blocks being tensioned relative to at least two other blocks to form one support unit, said support unit positioned at the ground surface and maintaining least one portion of the upright member.

11. The apparatus of claim 10 which additionally comprises a pair of support units, each constructed as described with respect to said one support unit of claim 10, said pair of support units each maintaining a portion of the upright member.

12. The apparatus of claim 10 in which at least one of said plurality of tensioning elements tension said central block with at least a pair of said plurality of blocks.

13. The apparatus of claim 10 which additionally comprises at least one ground penetrating member extending through at least one of said plurality of blocks.

14. The apparatus of claim 10 in which at least one block of said plurality of blocks additionally stacks atop a portion of said plurality of blocks, and additionally comprises at least one ground penetrating member extending through at least a pair of said plurality of blocks stacked relative to one another.

15. The apparatus of claim 10 in which at least one of said plurality of tensioning elements tensions said central block with at least a pair of said plurality of blocks.
